(19) United States
(12) Patent Application Publication
(10) Pub. No.: US 2017/0165944 A1
(43) Pub. Date: Jun. 15, 2017

(54) AUTOMOTIVE GLASS BLACKOUT AREA

(71) Applicant: FORD GLOBAL TECHNOLIGIES, LLC, Dearborn, MI (US)

(72) Inventors: Adrian Nania, Rochester, MI (US); Spencer Monroe Dinkins, III, Rochester Hills, MI (US)

(21) Appl. No.: 14/969,972

(22) Filed: Dec. 15, 2015

(51) Int. Cl. B32B 17/10; B32B 27/40; B32B 27/30; B60J 3/00; B32B 3/08

(52) U.S. Cl. CPC B32B 17/10348; B60J 3/007; B32B 3/08; B32B 17/10293; B32B 27/304; B32B 27/40; B32B 2605/00

(57) ABSTRACT

An automotive glass for a vehicle is provided by a glass panel including an exterior layer defining a non-ceramic UV-blocking band on an edge of the glass panel. In an embodiment, the exterior layer is a polymer film sheet sized to match a size dimension of the glass panel. The polymer film sheet may include a tinted portion bordering a substantially transparent interior. In another embodiment, the exterior layer is a non-ceramic paint applied to a border of the glass panel.

### TECHNICAL FIELD

This disclosure relates generally to automotive glass. More particularly, the disclosure relates to an improved automotive glass panel including a non-ceramic UV-blocking area.

### BACKGROUND

Automotive glass panels such as windshields and rear windows are typically provided with a blackout area bordering the panel. This blackout area or blackout band improves appearance, particularly for glass panels set into minimal moldings, by hiding the adhesive bead used to attach the glass panel in place. The blackout band also is functional, covering and protecting the adhesive bead used to secure the glass panel in place from exposure to ultraviolet light, thus improving the strength and durability of the adhesive bond. Conventionally, glass panels for fixed (non-movable) glass panels such as windshields, rear windows, etc. include a blackout band provided as a frit comprising, for example, a screen-printed fired enamel coating of ceramic automotive glass enamel paint. As is well-known, ceramic automotive glass enamel paints are glass enamels that fire onto automotive glass during the bending process above 600° C., forming a glossy inorganic layer. The glass enamel paint dries and sinters during the forming and heat-strengthening of the glass panel, forming the frit. Such paints consist of an inorganic component, a color powder, and an organic component or medium which determines the drying mechanism after screen printing. The color powder may include a variety of components, including glass frit fluxes with Pb, Ti, Zr, Al, Na, K, Li, Ca, Bi, B, Zn, and/or Si oxides, a stain comprising Cu, Co, Fe, Ni, Mn, and/or Cr oxides, and additional oxide, sulfide, and metal additives.

The frit is useful in that it increases porosity of the portion of the glass panel covered by the frit, thus increasing bonding surface area for the adhesive bead. However, the screen printing process used to apply the fired enamel coating can weaken the glass panel at the site of application, particularly in the case of thinner, lighter weight glass materials. With such glasses, thermal expansion and contraction must be very precisely controlled during the tempering process, leading to manufacturing complexity. It is also known that addition of pigments, metals, and other inorganic additives included in enamel coatings as summarized above will influence the thermal expansion characteristics of glass-ceramic compositions. Residual stress caused by significant differences in expansion between the enamel coating and lightweight glass such as soda-lime glass can decrease glass strength. To improve strength, it is desirable for the enamel expansion coefficient to be less than the glass expansion coefficient.

If expansion coefficients are not well controlled, breakage can occur during processes such as annealing and tempering. Further, the chemistry of the enamel frit can ion-exchange with, for example, soda-lime glass and also result in further weakening of the glass at the frit. Smaller, more mobile Li+ ions in the enamel coating can migrate and exchange with larger Na+ ions in the glass, resulting in a tensile area of stress below the enamel coating. To avoid such issues, the automotive industry is exploring use of laminated glass panels. However, laminated glass is typically costly, and requires compromises in glass stiffness compared to tempered glass.

Accordingly, a need is identified in the art for alternatives to fired enamel coatings as a blackout area for a glass panel, without incurring losses in strength attendant to fired enamel coatings on glass panels or stiffness/strength reductions attendant to laminated lightweight glass panels.

### SUMMARY

In accordance with the purposes and benefits described herein, in one aspect an automotive glass for a vehicle is provided, comprising a glass panel including an exterior layer defining a non-ceramic UV-blocking band on an edge of the glass panel. In an embodiment, the exterior layer defining the non-ceramic UV-blocking band is a polymer film sheet sized to match a size dimension of the glass panel. The polymer film sheet may comprise a tinted portion bordering a substantially transparent interior. The polymer film sheet may be attached to the glass panel by an adhesive. In embodiments, the polymer film is selected from the group consisting of a clear-coated polyvinyl chloride (PVC), a PVC, a clear-coated polyurethane (PU), and others.

In other embodiments, the exterior layer is a non-ceramic paint applied to a border of the glass panel to define the non-ceramic blackout band. The non-ceramic may be applied to the glass panel border using a template.

In another aspect, a method is provided for manufacturing an automotive glass panel, comprising providing a glass panel and applying an exterior layer to the glass panel to define at least a non-ceramic UV-blocking band bordering the glass panel. In embodiments, the method may include a step of applying a polymer film sheet exterior layer as described above to the glass panel, the polymer film sheet comprising a tinted edge bordering a substantially transparent interior to define the non-ceramic UV-blocking band. The polymer film sheet may be sized to match a size dimension of the glass panel and attached to the glass panel by a suitable adhesive. The polymer film sheet may be selected from the group consisting of a clear-coated polyvinyl chloride (PVC), a PVC, a clear-coated polyurethane (PU), and others.

In other embodiments, the method includes a step of applying a non-ceramic paint exterior layer to a border of the glass panel to define the non-ceramic UV-blocking band. A template may be used to apply the non-ceramic enamel paint.

In the following description, there are shown and described embodiments of the disclosed glass panel including a non-ceramic UV-blocking band. As it should be realized, the non-ceramic UV-blocking band is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed glass panel including a non-ceramic UV-blocking band, and together with the description serve to explain certain principles thereof. In the drawing:

FIG. 1 depicts a glass panel windshield affixed to a vehicle;

FIG. 2 depicts an embodiment of a glass panel including a UV-blocking band according to the present disclosure;

FIG. 3 depicts an alternative embodiment of a glass panel including a UV-blocking band according to the present disclosure; and

FIG. 4 depicts a moonroof including a UV-blocking band according to the present disclosure.

Reference will now be made in detail to embodiments of the glass panel including a non-ceramic UV-blocking band, examples of which are illustrated in the accompanying drawing figures.

### DETAILED DESCRIPTION

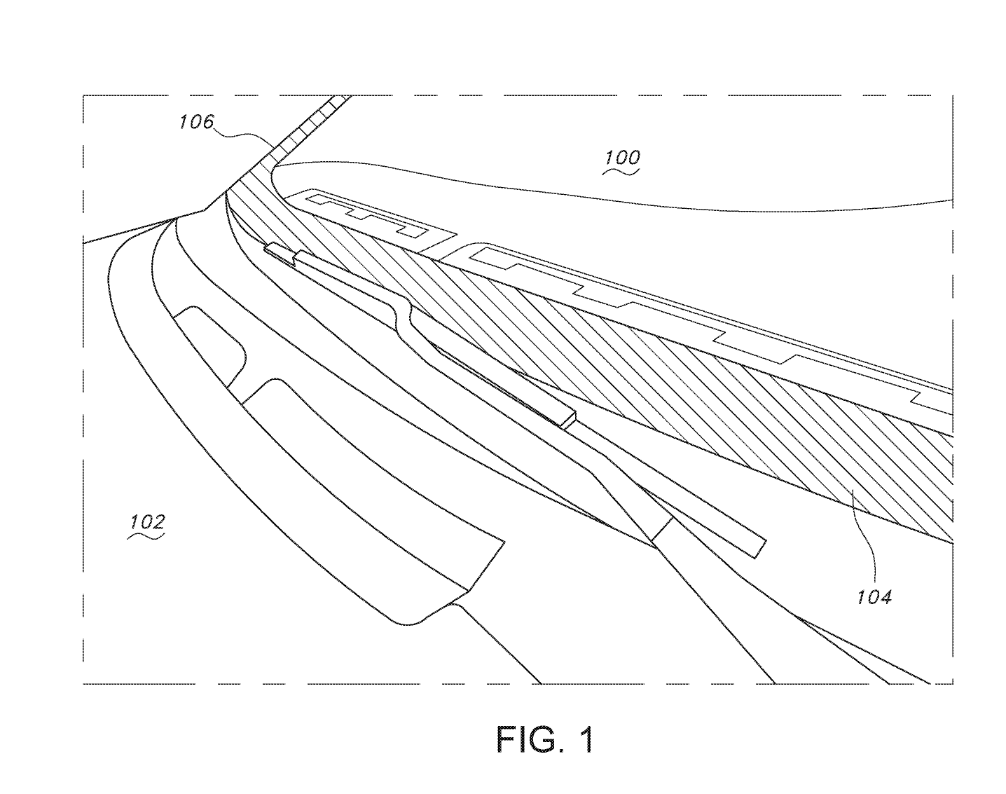

As set forth above and with reference to FIG. 1, it is known to provide a glass panel 100 as, for example, a fixed-panel windshield and/or rear window for a vehicle 102. The glass panel 100 includes a UV-blocking frit 104 bordering the panel for the purposes summarized above, and on installation is retained in place in part by a molding 106 and in part by an adhesive bead (not visible in this view).

The present disclosure provides novel glass panels including a non-ceramic UV-blocking band, and methods of making. The processing involved in making a glass panel for automotive use is well-known, and does not require extensive discussion herein. The non-ceramic UV-blocking band is defined by an exterior layer applied to a surface of the glass panel.

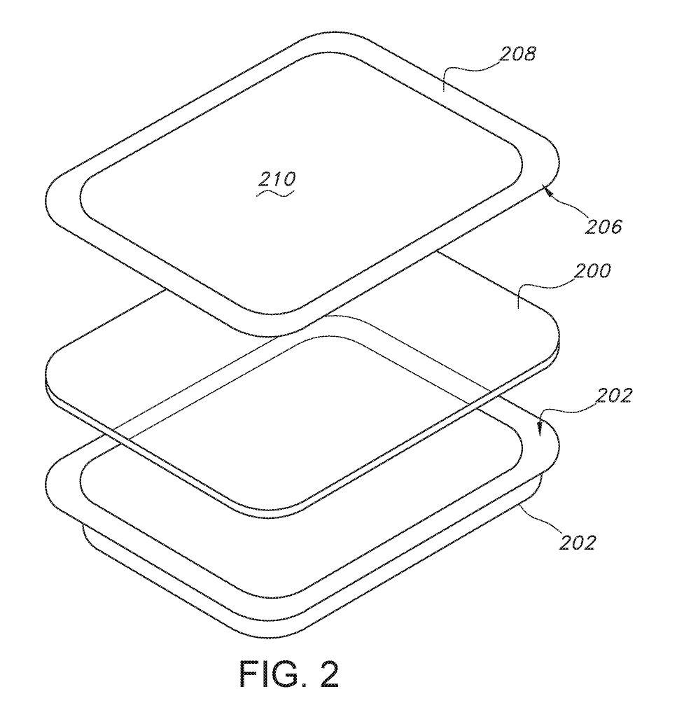

In an embodiment (see FIG. 2), a glass panel 200 is provided. The glass panel 200 will be in a final configuration, i.e. a pre-determined size dimension and curvature according to the vehicle to which it will be attached, and will already have gone through the forming and tempering processes as appropriate for the type of glass (tempered and/or laminated) used. A blackout primer 202 is applied to a surface of the glass panel, which as is known provides a better bond between a glass adhesive bead 204 and a surface of a vehicle (not shown in this figure) to which the glass panel 200 is adhered. A polymer film sheet 206 is applied to a surface of the glass panel 200 opposed to the surface to which the blackout primer 202 is applied. As will be appreciated, the polymer film sheet may be sized to match a size dimension of the glass panel 200 before or after application to the glass panel 200. The polymer film sheet 206 is applied to the glass panel 200 using a suitable adhesive, for example an adhesive backing applied to the film.

The polymer film sheet 206 includes at least a tinted or blackened portion defining a non-ceramic UV-blocking band 208 bordering the polymer film sheet. The polymer film sheet 206 also includes in the depicted embodiment a substantially transparent interior 210 allowing visibility through the glass panel 200 when the polymer film is applied.

In embodiments, the polymer film sheet 206 may be manufactured of a variety of polymers, including without intending any limitation clear-coated polyvinyl chloride (PVC), a PVC, a clear-coated polyurethane (PU), and others. In specific embodiments, commercially available UV-blocking films may be utilized, including without intending any limitation FTA 9055 J clear-coated PVC, FUS1007 PVC, and PUL2000 series clear-coated PU, all provided by 3M, St. Paul Minn.

Numerous advantages accrue to this embodiment. Screen printing equipment and attendant maintenance, and use of screen printing processes to create a frit as is done conventionally are not required. Thus, manufacturing overhead is reduced. By omitting the traditional fired glass ceramic enamel frit, the glass strength in the UV-blocking band area is not compromised. Size restrictions for blackout bands imposed by FMVSS regulations for fired enamel coatings or frits do not apply, since the process of application does not compromise glass strength. When the glass panel 200 is a tempered glass panel, by applying the polymer film sheet 206 to an already-tempered glass panel 200 the stiffness properties of tempered glass are made available, and also the cost of laminated glass panels is avoided. In turn, by including the polymer film sheet 206 on a surface of the glass panel 200 that will face outwardly from the vehicle on installation, an extra layer of protection is provided against chips, cracks, etc. The film sheet also assists in maintaining the integrity of the glass panel 200 in the event of an impact thereto.

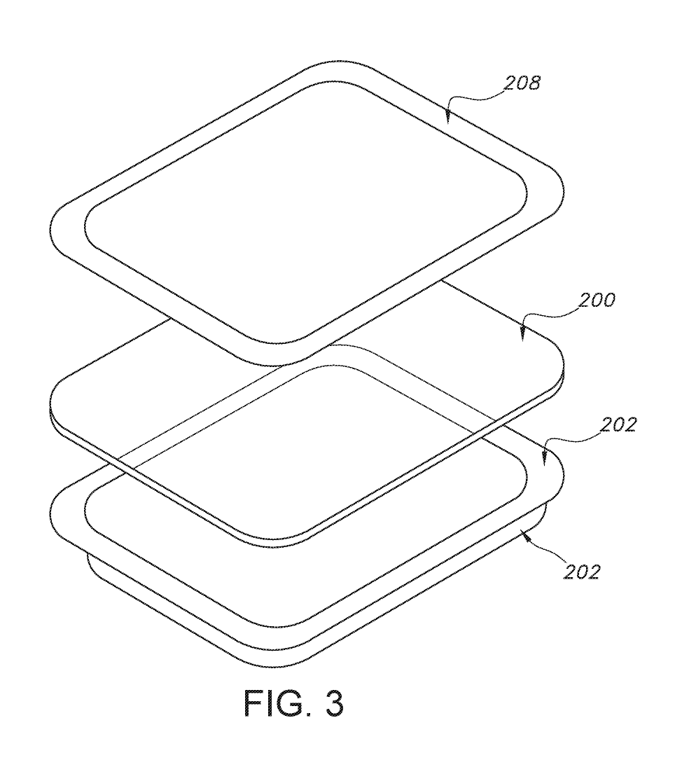

In an alternative embodiment (see FIG. 3), the non-ceramic UV-blocking band 208 bordering the glass panel 200 is provided by applying a suitable non-ceramic paint, such as by a template, to a border of the glass panel. As used herein, the term non-ceramic paint means a paint that is not a ceramic automotive glass enamel paint as that term is understood by the skilled artisan and as is further defined above. In embodiments, any suitable non-ceramic paint may be utilized.

Numerous advantages accrue to this embodiment. Screen printing equipment and attendant maintenance, and use of screen printing processes to create a frit as is done conventionally are not required. Thus, manufacturing overhead is reduced. By omitting the traditional frit, the glass strength in the non-ceramic UV-blocking band area is not compromised. Size restrictions for blackout bands imposed by FMVSS regulations for fired enamel coatings or frits do not apply, since the process of application does not compromise glass strength.

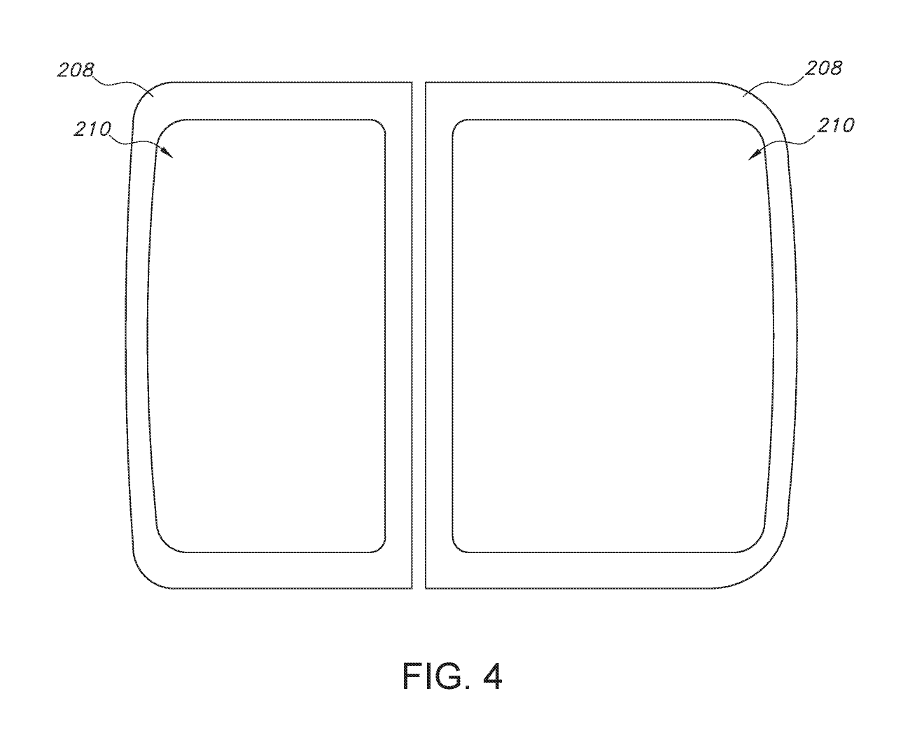

Obvious modifications and variations are possible in light of the above teachings. For example, the applicability of the described non-ceramic UV-blocking band is not restricted to fixed glass panels such as windshields and rear windows, but instead also finds use in alternative applications such as moonroofs (see FIG. 4). As shown in the drawing figure, in one embodiment the UV-blocking band 208 is of a four-piece construction and includes a substantially transparent center portion 210. Other contemplated uses include without intending any limitation panoramic roofs, fixed-glass roofs, and backlights. All such modifications and variations are within the scope of the appended claims when interpreted in accordance with the breadth to which they are fairly, legally and equitably entitled.

What is claimed:

1. A glass panel for a vehicle, comprising an exterior layer defining a non-ceramic UV-blocking band on an edge of the glass panel.

2. The glass panel of claim 1, wherein the exterior layer defining the non-ceramic UV-blocking band is a polymer film sheet sized to match a size dimension of the glass panel.

3. The glass panel of claim 2, wherein the polymer film sheet comprises a tinted portion bordering a substantially transparent interior.

4. The glass panel of claim 2, wherein the polymer film sheet is attached to the glass panel by an adhesive.

5. The glass panel of claim 2, wherein the polymer film is selected from the group consisting of a clear-coated polyvinyl chloride (PVC), a PVC, and a clear-coated polyurethane (PU).

6. The glass panel of claim 1, wherein the exterior layer is a non-ceramic paint applied to a border of the glass panel to define the non-ceramic UV-blocking band.

7. The glass panel of claim 6, wherein the non-ceramic paint is applied to the glass panel border using a template.

8. The glass panel of claim 1, wherein the glass panel is shaped to a desired configuration prior to inclusion of the exterior layer.

9. A vehicle including the glass panel of claim 1.

10. A method for manufacturing an automotive glass panel, comprising:
providing a glass panel; and
applying an exterior layer to the glass panel, the exterior layer defining at least a non-ceramic UV-blocking band bordering the glass panel.

11. The method of claim 10, comprising applying a polymer film sheet exterior layer to the glass panel, the polymer film sheet comprising a tinted edge bordering a substantially transparent interior to define the non-ceramic UV-blocking band.

12. The method of claim 11, including sizing the polymer film sheet to match a size dimension of the glass panel.

13. The method of claim 12, including attaching the polymer film sheet to the glass panel by an adhesive.

14. The method of claim 11, including selecting the polymer film sheet from the group consisting of a clear-coated polyvinyl chloride (PVC), a PVC, and a clear-coated polyurethane (PU).

15. The method of claim 10 comprising applying a non-ceramic paint exterior layer to a border of the glass panel to define the non-ceramic UV-blocking band.

16. The method of claim 15, including applying the non-ceramic paint to the glass panel border using a template.

17. The method of claim 10, including a step of forming the glass panel to a desired configuration prior to the step of applying the exterior layer.
